(19) United States
(12) Patent Application Publication
(10) Pub. No.: US 2018/0260298 A1
(43) Pub. Date: Sep. 13, 2018

(54) Method and Device for Reporting Mobile Terminal Behaviors

(71) Applicants: LE HOLDINGS (BEIJING) CO., LTD, Beijing (CN); LE SHI INTERNET INFORMATION & TECHNOLOGY CORP., BEIJING, Beijing (CN)

(72) Inventors: Qigang WU, BEIJING (CN); Ruijie ZHANG, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/119,846

(22) PCT Filed: May 27, 2016
(86) PCT No.: PCT/CN2016/083724

§ 371 Date: Aug. 18, 2016

(30) Foreign Application Priority Data
Nov. 30, 2015 (CN) 201510857536.X

(51) Int. Cl. G06F 11/34; H04W 24/10; H04W 8/20

(52) U.S. Cl. CPC G06F 11/3438; H04W 8/205; H04W 24/10

(57) ABSTRACT

Disclosed is a method and device for reporting mobile terminal behaviors, including: acquiring a configuration information from a server in a preset time interval continuously; determining whether the configuration information acquired before and after the preset time interval is the same; if it is the same, then prolonging the preset time interval by a modified duration; if it is different, then resetting the preset time interval to the initial duration; and monitoring a user's behavior according to the configuration information, when an occurrence of the user's behavior is monitored, acquiring the behavior data of the user's behavior from local and reporting the behavior data to the server.

### CROSS-REFERENCE TO RELATED APPLICATIONS

This application is a continuation of International Application No. PCT/CN2016/083724, filed May 27, 2016, which is based upon and claims priority to Chinese Patent Application No. 201510857536.X, filed Nov. 30, 2015, the entire contents of all of which are incorporated herein by reference.

### TECHNICAL FIELD

The present disclosure relates to mobile communication technology, in particular to a method and device for reporting mobile terminal behaviors.

### BACKGROUND

In the circumstances of high development of mobile communication technology and wide utilization of mobile terminals, it is more and more valuable to analyze mobile terminal behaviors. At present, the various types of commonly used mobile terminals such as mobile phone, PAD and other mobile terminals are provided with a behavior reporting system used for recording the specific operating behaviors on the mobile terminals by the user and uploading them to the server for statistical analysis, and the analysis results will become a basis for providing better service to the user.

The main functions of the existing behavior reporting system are as what follows: 1) acquiring configuration information from the server; 2) reporting the behavior data by using two threads of Config thread and Message Process thread. Specifically, the Config thread acquires configuration information from the server every a fixed time interval, and the Message Process thread reports the behavior data recorded within a reporting period every the fixed reporting period based on the configuration information acquired by the Config thread. Thus, in the traditional method, each thread will wait for a time slice periodically and start to work until depletion of the time, this will cause the thread idle to run in free time to result in CPU consumption, so that the unnecessary power consumption is increased.

### SUMMARY

In view of this, an object of the embodiment of the present disclosure is to provide a method and device for reporting mobile terminal behaviors for reducing the power consumption while the mobile terminal reports the behavioral data.

Based on the above-described object of the embodiment of the present disclosure, it is provided a method for reporting mobile terminal behaviors, the method as an embodiment includes:

acquire configuration information from a server in a preset time interval continuously;
determine whether the configuration information acquired before and after the preset time interval is the same; prolong the preset time interval by a modified duration, if the configuration information acquired before and after the preset time interval is the same; reset the preset time interval to an initial duration, if the configuration information acquired before and after the preset time interval is different; and
monitor a user's behavior according to the configuration information, when the user's behavior is monitored, acquiring the behavior data from local and report the behavior data to the server.

In some embodiments, the method further includes:

receive an acquisition instruction from the server to acquire the configuration information from the server; and
reset the preset time interval to an initial duration.

In some embodiments, after the step of prolonging the preset time interval by a modified duration, the method further includes:

compare the preset time interval with a preset duration threshold;
reset the preset time interval to an initial duration if the preset time interval is determined to be more than the preset duration threshold.

In some embodiments, the method further includes:

record the reset times of resetting the preset time interval to the initial duration within a preset period; and
update the modified duration according to the preset period and the reset times.

In some embodiments, when acquiring the behavior data from local, if network connection is unavailable, then the method further includes:

Store temporally the behavior data acquired within the period of unavailable network connection and monitor continuously the status of network connection; and
report the behavior data temporally stored to the server when the network connection becomes available.

Another aspect of the present disclosure, it is provided an electronic device, the electronic device as an embodiment includes:

at least one processor(s); and
a memory communicably connected with the at least one processor for storing instructions executable by the at least one processor, wherein execution of the instructions by the at least one processor causes the at least one processor to;
acquire configuration information from a server in a preset time interval continuously;
determine whether the configuration information acquired before and after the preset time interval is the same; prolong the preset time interval by a modified duration, if the configuration information acquired before and after the preset time interval is the same; reset the preset time interval to an initial duration, if the configuration information acquired before and after the preset time interval is different; and
monitor a user's behavior according to the configuration information, when an occurrence of the user's behavior is monitored, acquire the behavior data of the user's behavior from local and report the behavior data to the server.

In some embodiments, wherein the at least one processor is further caused to:

receive an acquisition instruction from the server to acquire the configuration information from the server; and
reset the preset time interval to an initial duration.

In some embodiments, wherein the at least one processor is further caused to:

compare the preset time interval with a preset duration threshold;
reset the preset time interval to an initial duration if the preset time interval is determined to be more than the preset duration threshold.

In some embodiments, wherein the at least one processor is further caused to:

record the reset times of resetting the preset time interval to the initial duration within a preset period; and
update the modified duration according to the preset period and the reset times.

In some embodiments, wherein the at least one processor is further caused to:

store temporally the behavior data acquired within the period of unavailable network connection and monitor continuously the status of network connection; and
report the behavior data temporally stored to the server when the network connection becomes available.

In a further another aspect of the present disclosure, it is provided a non-transitory computer-readable storage medium storing executable instructions that, when executed by an electronic device with a touch-sensitive display, cause the electronic device to:

acquire configuration information from a server in a preset time interval continuously;
determine whether the configuration information acquired before and after the preset time interval is the same; prolong the preset time interval by a modified duration, if the configuration information acquired before and after the preset time interval is the same; reset the preset time interval to an initial duration, if the configuration information acquired before and after the preset time interval is different; and
monitor a user's behavior according to the configuration information, when the user's behavior is monitored, acquire the behavior data from local and report the behavior data to the server.

In some embodiments, the non-transitory computer-readable storage medium further caused the electronic device to:

receive an acquisition instruction from the server to acquire the configuration information from the server; and
reset the preset time interval to an initial duration.

In some embodiments, the non-transitory computer-readable storage medium further caused the electronic device to:

compare the preset time interval with a preset duration threshold; and
reset the preset time interval to an initial duration if the preset time interval is determined to be more than the preset duration threshold.

In some embodiments, the non-transitory computer-readable storage medium further caused the electronic device to:

record the reset times of reset the preset time interval to an initial duration within a preset period; and
update the modified duration according to the preset period and the reset times.

In some embodiments, the non-transitory computer-readable storage medium further caused the electronic device to:

store temporally the behavior data acquired within the period of unavailable network connection and monitor continuously the status of network connection; and
report the behavior data temporally stored to the server when the network connection becomes available.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic flow diagram of a method for reporting a mobile terminal behavior according to an embodiment of the present disclosure.

FIG. 2 is a schematic flow diagram of a method for reporting a mobile terminal behavior according to another embodiment of the present disclosure.

FIG. 3 is a schematic view of an device for reporting a mobile terminal behavior according to an embodiment of the present disclosure.

### DETAILED DESCRIPTION

The present disclosure is described more fully hereinafter with reference to the accompanying drawings so that the objects, technical solutions and advantages of the present disclosure will become more apparent.

The embodiments of the present disclosure are applied for a behavior-reporting process of mobile terminal, wherein the term “behavior reporting process” means that the specific user's behaviors are monitored and recorded to generate behavior data and report it to the server for further analysis and processing. The behavior reposting generally includes two stages of acquiring configuration information from the server and reporting the behavior data to the server, wherein the configuration information is generated at the server for setting relevant parameters of behavior reporting for a mobile terminal, that is, “telling” the mobile terminal what user's behaviors have to be monitored and reported, the reporting priority of different users' behaviors, etc. acquiring configuration information and reporting behavior data generally are implemented by individual function modules and the corresponding threads (Config thread and Message Process thread) will be established in the system to work during specific implementation. as described in Background, they are worked in a high power consumption way with a fixed period. The embodiments of the invention provide a low power consumption solution of reporting mobile terminal behavior in terms of the problems in the prior art.

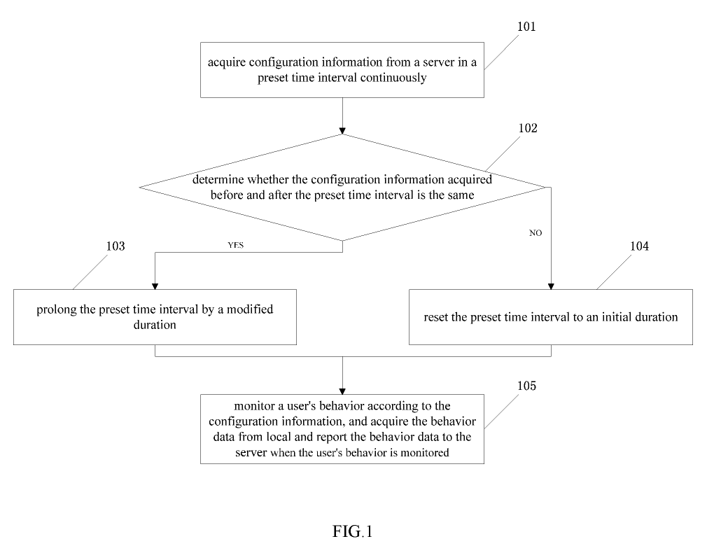

At first, an embodiment of the present disclosure provides a method for reporting mobile terminal behaviors, referring to FIG. 1, showing a schematic flow diagram of a method for reporting a mobile terminal behavior according to an embodiment of the present disclosure.

The method for reporting mobile terminal behavior includes the following steps:

In step 101, acquire configuration information from a server in a preset time interval continuously.

In the step, the configuration information is acquired from the server once every preset time interval. Since only one configuration information may become effective, the acquired configuration information will be stored in an update way, that is, the later acquired new configuration information will cover the earlier effective configuration information in time sequence.

The preset time interval has a default initial duration, which may be varied from minutes to hours depending on various situations. In this embodiment, the initial duration of the preset time interval is set to 1 hour, that is, the configuration information is acquired from the server once every one hour.

In step 102: determine whether the configuration information acquired before and after the preset time interval is the same; execute Step 103, if the configuration information acquired before and after the preset time interval is the same; execute Step 104, if the configuration information acquired before and after the preset time interval is different.

In this step, from the time starting to acquire the configuration information, two successive configuration information acquired before and after every preset time interval will be compared with each other to determine it is the same or not.

In step 103: prolong the preset time interval by a modified duration.

If both successive configuration information acquired before and after is the same, it may be deemed that the configuration information generated at the server end should not be changed, so that the preset time interval may be prolonged. The specific way to prolong the preset time interval is to add a modified duration into the duration of the preset time interval. The modified duration may be a predetermined unit time for prolonging the preset time interval and the preset time interval is added by one modified duration every time.

In step 104: reset the preset time interval to an initial duration.

When both successive configuration information acquired before and after is not the same, it shows that the configuration information generated at the server is changed, so that the preset time interval will be reset to the initial duration.

In the first three steps of the embodiment, the modified duration is set to 1 hour which is the same as the initial time interval. In the specific implementation, when both successive configuration information acquired before and after is determined firstly as the same, the preset time interval will be set to 2 hours, and then when both successive configuration information acquired before and after is determined as the same again, the preset time interval will be set to 3 hours, and so on, that is, the duration of the preset time interval will be increased in an equal difference. When both successive configuration information acquired before and after is determined to be not the same, the preset time interval will be reset to the initial duration.

Obviously, the modified duration may be set depending on various situations, which may be set to a value larger or smaller than the initial duration of the preset time interval, such as half or double of the initial duration of the preset time interval.

In step 105:monitor a user's behavior according to the configuration information, and acquire the behavior data of the user's behavior from local and reporting the behavior data to the server when the user's behavior is monitored.

The process of reporting the behavior data is executed in this step. In common mobile terminal system, a function module for monitoring the user's behavior has been provided, such as loop handler in Android system. Thus, the method of this embodiment of the present disclosure no longer provides a function module for specifically generating the behavior data individually, but the behavior data is acquired directly from the local corresponding function module. Specifically, a user's behavior is monitored according to the configuration information, when an occurrence of the user's behavior is monitored, the behavior data corresponding to the monitored user's behavior is acquired from local which will be reported to the server immediately. That is to say, a real-time behavior data reporting manner is implemented, wherein once the user's behavior is monitored, the behavior data is reported immediately, but while no user's behavior is monitored, no report will be implemented. Such real-time behavior data report manner may adopt for the general features the user use on a mobile terminal, because it is not a frequent situation that the user occurs the intensive and long time lasting behaviors, it is unreasonable for the manner of reporting in a fixed period in the prior art. The problem may be addressed by the manner of the step.

As may be seen from the embodiment, the present disclosure optimizes the processes of acquiring configuration information and the reporting process in a fixed period in the prior art. As for the process of acquiring configuration information, when both successive configuration information acquired is the same, the preset time interval will be prolonged to make the time interval of next acquisition of configuration information prolong, so that the numbers of communication with the server are reduced in a unit time than that in prior art, so as to effectively reduce the power consumption of the mobile terminal. As for the report process, it employs a manner of real-time reporting the behavior data, so that while there is no occurrence of user's behavior in a long time, the mobile terminal will not communicate with the server, which also reduces the power consumption of the mobile terminal.

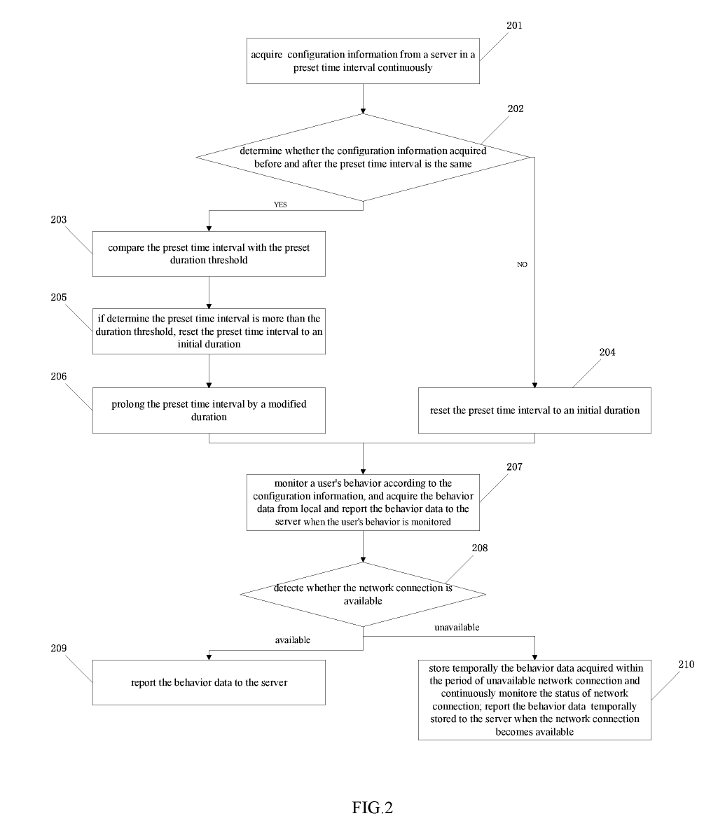

Referring to FIG. 2, it is a schematic flow diagram of a method for reporting a mobile terminal behavior according to another embodiment of the present disclosure.

The method for reporting mobile terminal behaviors as another specific embodiment includes the following steps of:

In step 201: acquire configuration information from a server in a preset time interval continuously;

In step 202: determine whether the configuration information acquired before and after the preset time interval is the same; if yes, then executing Step 203; if no, then executing Step 204;

In step 203: prolong the preset time interval by a modified duration;

In step 204: reset the preset time interval to the initial duration;

Step 205: compare the preset time interval with the preset duration threshold;

when the situation of determine the both configuration information acquired before and after the preset time interval is the same and prolong the preset time interval is continuously occurred, the preset time interval will be longer and longer. obviously, the too long preset time interval may affect the timely acquisition of later new configuration information, so that in this step, it is also provided with a preset duration threshold for limiting the maximum duration of the preset time interval;

In step 206: if determine the preset time interval is more than the duration threshold, reset the preset time interval to the initial duration;

wherein once the preset time interval is modified every time, it will be compared with the duration threshold, and if the preset time interval is more than the duration threshold, the preset time interval will be reset to the initial duration; in this embodiment, the duration threshold may be set to 24 hours;

In step 207: monitor a user's behavior, when an occurrence of the user's behavior is monitored, acquiring the behavior data of the user's behavior from local;

In step 208: detected whether the network connection is available; if available, then execute Step 209; if unavailable, then execute Step 210;

wherein after acquire the behavior data from local function module, as an alternative manner of uploading the behavior data to the server in real-time, so that after acquire the behavior data, whether the network connection (i.e., communication with the server) is available is firstly detected.

In step 209: report the behavior data to the server; If the network connection is available, immediately establish a communication connection with the server to report the behavior data;

In step 210: temporally store the behavior data acquired within the period of unavailable network connection and continuously monitor the status of network connection; and when the network connection becomes available, report the temporally stored behavior data to the server immediately;

wherein if the network connection is unavailable, then all behavior data acquired within the period of unavailable network connection is temporally stored; and at the same time, the status of network connection is continuously monitored; and when the network connection becomes available, the previously temporally stored behavior data is reported to the server.

In some other embodiments, the method for reporting mobile terminal behaviors may further includes the step of receiving an acquisition instruction from the server to acquire the configuration information from the server; and resetting the preset time interval to the initial duration.

That is to say, when the server generates new configuration information which is varied than before, the server will actively send an acquisition instruction to the mobile terminal for informing the mobile terminal to acquire the new configuration information. When the mobile terminal receives the acquisition instruction, it will immediately acquire the new configuration information from the server. Accordingly, after receiving the latest configuration information, the preset time interval will be reset to the initial duration.

In some other embodiments, the method for reporting mobile terminal behaviors may further includes the steps of recording the reset times of resetting the preset time interval to the initial duration within a preset period; and updating the modified duration according to the preset period and the reset times.

The steps are used for updating the modified duration depending on the actual situation. Specifically, a time period (e.g. 24 hours) is firstly predetermined and then the reset times of resetting the preset time interval to the initial duration within this period is recorded, that is, the modified number of the acquired configuration information is recorded. The time-length of the period is divided by the reset times to get a updated value of the modified duration and the updated value will be used to modify the preset time interval in subsequent processes. When the reset times are smaller, the obtained updated value may be larger, but it will be adverse to the timely acquisition of new configuration information for using of a larger updated value. Thereby, it is also possible to predetermine a modified duration threshold for limiting the modified duration, and after obtaining the updated value of the modified duration, the updated value is compared with the modified duration threshold, if the updated value is larger than the modified duration threshold, then this updated value is abandoned or the updated value is reset to the modified duration threshold.

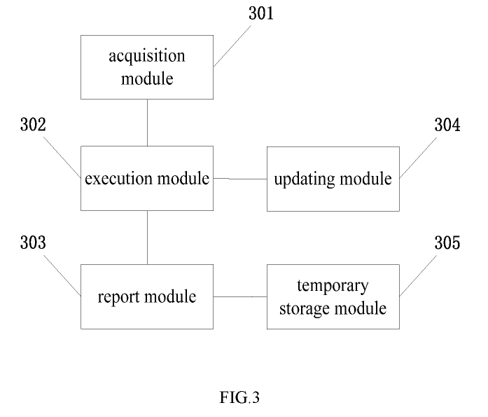

In another aspect, an embodiment of the present disclosure provides a device for reporting mobile terminal behaviors, referring to FIG. 3, showing a schematic view of a device for reporting a mobile terminal behavior according to an embodiment of the present disclosure.

The device for reporting mobile terminal behavior includes:
an acquisition module 301, for acquiring a configuration information from a server in a preset time interval continuously;
an execution module 302, for determining whether the configuration information acquired before and after the preset time interval is the same; if it is the same, then prolonging the preset time interval by a modified duration; if it is different, then resetting the preset time interval to the initial duration; and
a report module 303, for monitoring a user's behavior according to the configuration information, when an occurrence of the user's behavior is monitored, acquiring the behavior data of the user's behavior from local and reporting the behavior data to the server.

As may be seen from the embodiment, the device for reporting mobile terminal behaviors provided by the present disclosure optimizes the processes of acquiring configuration information and reporting the behavior data which worked in a fixed period in the prior art. As for the process of acquiring configuration information, when both successive configuration information acquired is the same, the preset time interval may be prolonged to make the time interval of next acquisition of configuration information be prolonged, so that the numbers of communication with the server are reduced in a unit time than that in traditional manner, so as to effectively reduce the power consumption of the mobile terminal. As for the process of reporting the behavior data, a manner of real-time reporting the behavior data is employed, so that while there is no occurrence of user's behavior in a long time, the mobile terminal may not communicate with the server, which also reduces the power consumption of the mobile terminal.

Alternatively, the execution module 302 is further used for comparing the preset time interval with a preset duration threshold; if determining that the preset time interval is more than the preset duration threshold, then resetting the preset time interval to the initial duration.

Alternatively, the device for reporting mobile terminal behaviors further includes a updating module 304, for recording the reset times of resetting the preset time interval to the initial duration within a preset period; and updating the modified duration according to the preset period and the reset times.

Alternatively, the device for reporting mobile terminal behaviors further includes a temporary storage module 305, for storing temporally the behavior data acquired within the period of unavailable network connection and monitoring continuously the status of network connection; and when the network connection becomes available, allowing the reporting module 303 to report the behavior data temporally stored to the server.

Alternatively, the acquisition module 301 is further used for receiving an acquisition instruction from the server to acquire the configuration information from the server; and allowing the execution module 302 to set the preset time interval to an initial duration.

In a further another aspect of the present disclosure, it is provided an electronic device, the electronic device as an embodiment includes: at least one processor(s); and a memory communicably connected with the at least one processor for storing instructions executable by the at least one processor, wherein execution of the instructions by the at least one processor causes the at least one processor to:

acquire a configuration information from a server in a preset time interval continuously;
determine whether the configuration information acquired before and after the preset time interval is the same; prolong the preset time interval by a modified duration, if the configuration information acquired before and after the preset time interval is the same; reset the preset time interval to an initial duration, if the configuration information acquired before and after the preset time interval is different; and
monitor a user's behavior according to the configuration information, and acquire the behavior data of the user's behavior from local and report the behavior data to the server when the user's behavior is monitored.

Preferably, wherein the at least one processor is further caused to: receive an acquisition instruction from the server to acquire the configuration information from the server; and reset the preset time interval to the initial duration.

Preferably, wherein the at least one processor is further caused to compare the preset time interval with a preset duration threshold; if the preset time interval is determined to be more than the preset duration threshold, then reset the preset time interval to the initial duration.

Preferably, to where in the at least one processor is further caused to record the reset times of reset the preset time interval to the initial duration within a preset period; and update the modified duration according to the preset period and the reset times.

Preferably, wherein the at least one processor is further caused to: store temporally the behavior data acquired within the period of unavailable network connection and monitor continuously the status of network connection; and report the t behavior data temporally stored to the server when the network connection becomes available.

In addition, typically, the device of the present disclosure may be a variety of electronic terminal devices such as mobile phone, personal digital assistant (PDA), tablet PC (PAD), smart TV, etc., so that the scope of the disclosure should not be limited to a specific type of electronic device. The system of the present disclosure may be applied in any one of the above electronic terminal device in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and system units may also be implemented by using a controller and a computer-readable storage medium for storing a computer program to make the controller to implement the above steps or unit functions.

Additionally, it should be appreciated that the computer-readable storage medium as described herein (for example, memory) may be volatile memory or nonvolatile memory, or may include both volatile memory and nonvolatile memory. As an example without any limitation, nonvolatile memory may include read only memory (ROM), programmable ROM (PROM), electrically programmable ROM (EPROM), electrically erasable programmable ROM (EEPROM), or flash memory. Volatile memory may include random access memory (RAM) which may act as external cache RAM memory. As an example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct RambusRAM (DRRAM). The disclosed aspects of the storage devices are intended to include, but not limited to these and other suitable types of memory.

Those skilled in the art will also understand that a combination of the illustrative logical sections, modules, circuits, and algorithm steps described in this disclosure may be implemented as electronic hardware, computer software, or both. To clearly illustrate the interchangeability between hardware and software, various illustrative components, sections, modules, circuits, and functions of steps have been generally described. Whether such function is implemented as software or hardware is depended on the particular application and the design constraints imposed on the whole system. Those skilled in the art may achieve the functions for each particular application in various ways, but such implementing decisions should not be interpreted as a departure from the scope of the present disclosure.

A combination of the illustrative logical sections, modules, and circuits may be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor may read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium may comprise RAM, ROM, EEPROM, CD-ROM or other optical disk storage, magnetic disk storage or other magnetic storage devices, or may be any other medium for carrying or storing the desired program codes in the form of instruction or data structures and may be accessed by or via a general purpose or special purpose computer. Also, any connection may be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and Blu-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality may also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely used for illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present disclosure, and there are many other variations of the different aspects of the present disclosure as described herein without description in the details for simplicity. Thus, any omissions, modifications, equivalent replacements and improvements made in the spirit and principles of the present disclosure should be included within the scopes of the present disclosure.

What is claimed is:

1. A method for reporting mobile terminal behaviors, comprising:
At a mobile terminal:
acquiring configuration information from a server in a preset time interval continuously;
determining whether the configuration information acquired before and after the preset time interval is the same; prolonging the preset time interval by a modified duration, if the configuration information acquired before and after the preset time interval is the same; resetting the preset time interval to an initial duration, if the configuration information acquired before and after the preset time interval is different; and
monitoring a user's behavior according to the configuration information, and acquiring the behavior data of the user's behavior from local and reporting the behavior data to the server when the user's behavior is monitored.

2. The method according to claim 1, wherein further comprising:
receiving an acquisition instruction from the server, and acquiring the configuration information from the server; and
resetting the preset time interval to the initial duration.

3. The method according to claim 1, wherein after the step of prolonging the preset time interval by a modified duration, the method further comprising:
comparing the preset time interval with a preset duration threshold; and
resetting the preset time interval to an initial duration if the preset time interval is determined to be more than the preset duration threshold.

4. The method according to claim 1, wherein further comprising:
recording are set times of resetting the preset time interval to the initial duration within a preset period; and
updating the modified duration according to the preset period and the reset number.

5. The method according to claim 1, wherein if a network connection is unavailable while acquiring the behavior data from local, the method further comprising:
storing temporally the behavior data acquired within a period of the unavailable network connection, and monitoring continuously a status of the network connection; and
reporting the behavior data temporally stored to the server when the network connection becomes available.

6. An electronic device, comprising:
at least one processor(s); and
a memory communicably connected with the at least one processor for storing instructions executable by the at least one processor, where in execution of the instructions by the at least one processor causes the at least one processor to:
acquire a configuration information from a server in a preset time interval continuously;
determine whether the configuration information acquired before and after the preset time interval is the same; prolong the preset time interval by a modified duration, if the configuration information acquired before and after the preset time interval is the same; reset the preset time interval to an initial duration, if the configuration information acquired before and after the preset time interval is different; and
monitor a user's behavior according to the configuration information, when the user's behavior is monitored, acquire the behavior data from local and reporting the behavior data to the server.

7. The electronic device according claim 6, wherein the at least one processor is further caused to:
receive an acquisition instruction from the server to acquire the configuration information from the server; and
reset the preset time interval to an initial duration.

8. The electronic device according claim 6, wherein the at least one processor is further caused to:
compare the preset time interval with a preset duration threshold; and
if the preset time interval is determined to be more than the preset duration threshold, then reset the preset time interval to an initial duration.

9. The electronic device according claim 6, wherein the at least one processor is further caused to:
record the reset times of resetting the preset time interval to an initial duration within a preset period; and
update the modified duration according to the preset period and the reset times.

10. The electronic device according claim 6, wherein the at least one processor is further caused to:
storing temporally the behavior data acquired within the period of unavailable network connection and monitor continuously the status of network connection; and
report the behavior data temporally stored to the server when the network connection becomes available.

11. A non-transitory computer-readable storage medium storing executable instructions that, when executed by an electronic device with a touch-sensitive display, cause the electronic device to:
Acquire a configuration information from a server in a preset time interval continuously;
Determine whether the configuration information acquired before and after the preset time interval is the same; prolong the preset time interval by a modified duration, if the configuration information acquired before and after the preset time interval is the same; reset the preset time interval to an initial duration, f the configuration information acquired before and after the preset time interval is different; and
monitor a user's behavior according to the configuration information, when the user's behavior is monitored, acquire the behavior data from local and report the behavior data to the server.

12. The non-transitory computer-readable storage medium according claim 11, further caused the electronic device to:
receive an acquisition instruction from the server to acquire the configuration information from the server; and
reset the preset time interval to an initial duration.

13. The non-transitory computer-readable storage medium according claim 11, further caused the electronic device to:
compare the preset time interval with a preset duration threshold; and
reset the preset time interval to an initial duration, if the preset time interval is determined to be more than the preset duration threshold.

14. The non-transitory computer-readable storage medium according claim 11, further caused the electronic device to:
record the reset times of reset the preset time interval to an initial duration within a preset period; and
update the modified duration according to the preset period and the reset times.

15. The non-transitory computer-readable storage medium according claim 11, further caused the electronic device to:
store temporally the behavior data acquired within the period of unavailable network connection and monitor continuously the status of network connection; and
report the behavior data temporally stored to the server when the network connection becomes available.
